(19) United States
(12) Patent Application Publication
(10) Pub. No.: US 2003/0219699 A1
(43) Pub. Date: Nov. 27, 2003

(54) Stepped root canal plugger

(76) Inventor: Howard Martin, Rockville, MD (US)

Correspondence Address: Royal W. Craig, Law Offices of Royal W. Craig, Suite 153, 10 North Calvert Street, Baltimore, MD, 21202, US

(21) Appl. No.: 10/153,254

(22) Filed: May 22, 2002

(51) Int. Cl. A61C 3/08

(52) U.S. Cl. 433/164

(57) ABSTRACT

Disclosed herein is an improved plugger design that utilizes a tapered conical tip having a stepped cross-section to create angular lateral displacement leading to a concurrent diagonal resultant force both in length and direction. The improved plugger design results in a main compaction that is a compounded displacement having vector quantities of both magnitude and direction throughout its working length due to the varying steps throughout the working length (as opposed to existing pluggers having a single point of pressure). This allows the gutta percha to be worked upon by several forces in different directions at the same time, which in turn distorts and compacts the gutta percha in various locations and directions to enable a more complete compaction and condensation within the root canal. Insertion length markings are also provided. The stepped plugger of the present invention with insertion markings achieves the fullest possible compaction condensation of the gutta percha. Moreover, the present invention's design is simple and straightforward, and can be economically manufactured.

### BACKGROUND OF THE INVENTION

1. Field of the Invention

The present invention relates to gutta percha compaction tools for use in root canal therapy and, more particularly, to an improved plugger having a stepped shaft design to enable the gutta percha to be compressed in multiple vectors as the plugger is inserted into the gutta percha.

2. Description of the Background

Successful root canal therapy consists of cleaning, shaping, and disinfecting the root canal system followed by a hermetic seal of the root canal system. The lack of a proper hermetic seal, or “obturation” of the root canal system is the most frequent cause of root canal failure. Gutta-percha is the material of choice for filling and sealing the root canal. Typically, hardened cones of gutta percha material are inserted into the root canal. Two things are required in order to properly manipulate the gutta-percha cones: heat and pressure. The correct amount of heat must be applied to properly soften the gutta-percha. Following this, positive pressure must be exerted on the softened material. As a result, the gutta-percha can flow to seal the entire root canal system and conform to the finest interior details.

There are a variety of specially designed hand held instruments that are presently used to compact and condense the gutta percha cones. One particular type of instrument used in obturating or condensing the gutta percha within the root canal system is a hand held plugger (also known as a “condenser”). Pluggers are round, conical shaped instruments with a flat or blunt end. They are used to compact or compress the gutta percha within the canal in a vertical fashion with the blunted flat tip. The problem with existing pluggers as presently used in endodontics is that the only force exerted on the gutta percha is at the end of the plugger (at the flat/blunt tip). This results only in a single scaler quantity in the apical root end direction. It would be far more desirable to be able to exert vertical blunt tip force as well as additional lateral and angular forces with the goal of compacting and condensing the gutta percha within the root canal in all three dimensions. This would create a fully three-dimensional volumetric fill and obturation to successfully hermetically seal the root canal in all three dimesions rather than just the vertical component.

Consequently, there remains a significant commercial need for a plugger that enables the gutta percha to be compressed in multiple vectors as the plugger descends within the gutta percha.

### SUMMARY OF THE INVENTION

It is, therefore, the primary object of the present invention to provide an improved design for a plugger instrument for use in obturating root canals which is capable of exerting a vertical blunt tip force on the gutta percha as well as additional lateral and angular forces with the goal of compacting and condensing the gutta percha more fully within the root canal in all three dimensions.

It is a further object to provide a plugger that creates a fully three-dimensional volumetric fill and obturation to successfully hermetically seal the root canal in all three dimesions rather than just the vertical component.

These and other objects are accomplished by an improved plugger design that utilizes a tapered conical tip having a stepped cross-section to create angular lateral displacement leading to a concurrent diagonal resultant force both in length and direction. The improved plugger design results in a main compaction that is a parallelogram with a polygonal component. The pressure exerted by the varying steps is compounded (as opposed to existing pluggers having a single point of pressure). The resultant displacement by the stepped plugger is a compounded displacement having vector quantities of both magnitude and direction throughout its working length due to the varying steps throughout the working length. This allows the gutta percha to be worked upon by several forces in different directions at the same time. This in turn distorts and compacts the gutta percha in various locations and directions, enabling a more complete compaction and condensation within the root canal. The stepped plugger of the present invention achieves the fullest possible compaction condensation of the gutta percha. Moreover, the present invention's design is simple and straightforward, and can be economically manufactured.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side cross-section of the stepped plugger 10.

FIG. 2 is a side perspective view of the stepped plugger 10 according to the present invention.

### DETAILED DESCRIPTION OF THE PREFERRED EMBODIMENTS

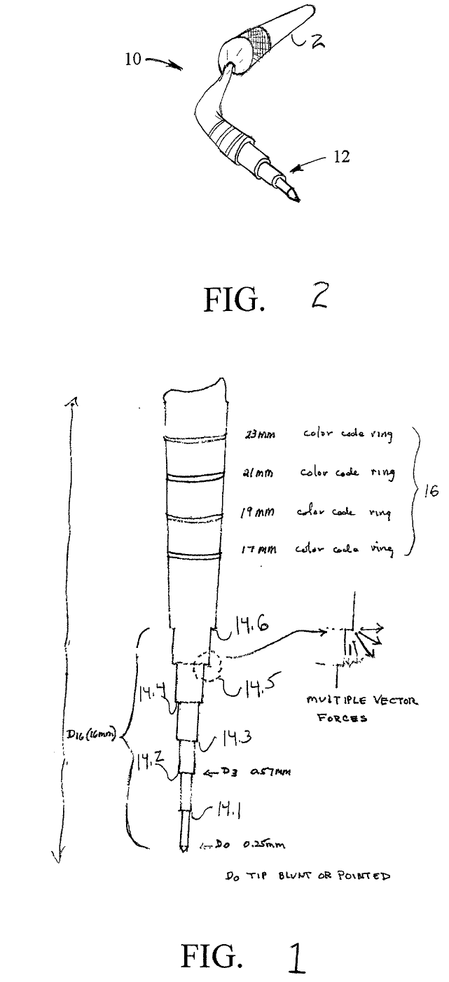

FIG. 1 is a side cross-section of the stepped plugger 10 according to the present invention, and FIG. 2 is a side perspective view.

With combined reference to FIGS. 1 and 2, the plugger 10 utilizes a tapered conical tip 12 that has a stepped cross-section. The stepped plugger 10 enables the gutta percha to be compressed in multiple vectors as the plugger descends within the gutta percha. The individual steps in the conical tapered plugger tip 12 create angular lateral displacement leading to a concurrent diagonal resultant force both in length and direction. The resultant displacement by the stepped plugger 110 is a compounded displacement composed of various displacements (versus a single vector component as with the traditional plugger). The tip 12 of the stepped plugger 110 can be attached to a long handled instrument in which the operative head can be at various angles to a shaft 2. Alternatively, the stepped plugger may be a finger instrument which are finger held with the finger handles bonded to the shaft. The handles are color coded to match the ISO endodontic instrument sizes.

As best seen in FIG. 1, the preferred embodiment includes a total of six functional steps 14.1-6 along tip 12. The steps 14.1-6 are based upon linear dimensional change with a 10% step every 2 mm along the working length. Thus, the first step 14.1 to appear along the tip 12 would be 2 mm from the distal end of the stepped plugger 10. Step 14.1 would step out 10% of the core material. Assuming an initial instrument diameter of 0.25 mm at D0, the core on a 16 mm working length D16 would be 0.29 mm minus the step of 0.029 mm leaving a core of 0.26 mm and a step of 0.029 mm at right angles to the central core. One skilled in the art would understand that the depth of the steps may vary based upon core size and shaft strength. Whereas the normal pressure of the traditional plugger is linear, the above-described stepped plugger 10 introduces multiple vector forces along various scalar angles. In addition, there is also a greater mechanical advantage. Under photoelastic strains the forces imparted by the stepped plugger 10 are two times greater than the traditional plugger based upon fringe line examination. Thus, the steps 14.1-6 in effect create a small lever arm that can be manipulated laterally and vertically by handle 2 to introduce angular forces that cannot be achieved by traditional pluggers.

Preferably, the taper on the complete shaft follows a 0.02 mm/mm taper. Therefore at the tip, a 0.25 mm tip (D0) will have a conical core taper D3 3 mm from the tip of 0.3 mm, and D16 16 mm from tip would be 0.57 mm.

The overall length of the tip 12 can range from 21 mm to 25 mm in length with a working range D16 up to 16 mm on said shaft. The tip 12 of plugger 10 can be formed from chrome plated or stainless steel, nickel titanium, other metals or various plastic substitutes as known in the art. It is also possible to form the tip 12 from stepped layers surrounding a central core of metal that does not extend to the distal end of the instrument. This way, the instrument can be as flexible as the central core of metal from which the steps protrude. Moreover, as the steps draw closer to the distal end, the tip 12 becomes more flexible.

The distal end of the plugger 10 is preferably a point 14 (as shown) for combined lateral vertical component of tip compression. The point 14 also allows for a deeper penetration into the mass of gutta pecha allowing for a more complete apical root end compaction than with the usual blunt end. According to Weber et al., J Endod 5;298, 1979, “the group in which the plugger/spreader tip could be inserted to within one mm of the prepared length of the canal had consdiderably less microleakage than did the group in which the distance between the plugger/spreader tip and prepared length was great”. Therefore, the preferred embodiment of the stepped plugger design includes pointed tip 14 to improve the penetration ability. However, one skilled in the art would understand that the distal end of the plugger 10 may take other forms, such as being blunt or flat-ended.

The steps 14.1-6 of the above-described plugger 10 enable the dentist to fully obturate the gutta percha in the root canal in all dimensions, with multiple compaction points, simultaneously, and with greater mechanical advantage and force for a superior obturation of the root canal. As seen at step 14.5 in the enlarged window (dotted lines) in FIG. 1, vector forces of different magnitudes of direction are applied throughout the working length of the stepped plugger 10. This is in contrast to the traditional plugger where only one force having a single scalar quantity in the apical root end direction is applied. The stepped plugger 10 if the present invention has vector quantities of both magnitude and direction throughout its entire working length due to the discrete steps 14.1-6 throughout the working length of tip 12. This allows the gutta percha to be worked upon by several forces in different directions at the same time, thereby distorting and compacting the gutta percha in various locations and enabling a more complete compaction and condensation within the root canal.

As stated previously, the ultimate goal of the plugger 10 is distortion or compaction of the gutta percha within the root canal for complete obturation. Inasmuch as the gutta percha is acted upon by several different forces in different directions at the same time, the stepped plugger 10 achieves the fullest compaction condensation of the gutta percha.

In addition to the steps 14.1-6, the shaft of the stepped plugger 10 preferably is provided with circular ring color-coded markings 16 for control of the depth penetration into the root canal. The circular color-coded markings 16 preferably begin just after the working length D16 of the tip 12, for instance, at 17 mm. The markings 16 continue at each 2 mm increments to just short of the overall length of tip 12, e.g., 23 mm. This way, the markings 16 generally conform to the average length of the prepared root canal, and this results in four (4) markings 16 with positions at 19 mm, 21 mm, 23 mm, 25 mm (all measured from the distal end of the tip 12). These figures are based on the average molar root canal being about 22 mm, although it should be understood that dimensions may vary somewhat. The imprint of markings 16 can be accomplished by color-coded rings encircling the tip 12, or alternatively by stenciling, laser or any conventional permanent mechanical imprinting method.

The foregoing configuration yields an improved design for plugger 10 that is more effective in obturating root canals because it is capable of exerting a vertical blunt tip force on the gutta percha as well as additional lateral and angular forces with the goal of compacting and condensing the gutta percha more fully within the root canal in all three dimensions. This in turn results in a fully three-dimensional volumetric fill and obturation to successfully hermetically seal the root canal in all three dimensions rather than just the vertical component.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A plugger instrument for use in obturating a root canal, comprising a cylindrical tip that tapers in diameter toward a distal end by a series of discrete radial steps spaced lengthwise along said tip.

2. The plugger instrument according to claim 1, wherein said discrete radial steps are spaced lengthwise from said tip to within a range of 16 mm to 25 mm therefrom.

3. The plugger instrument according to claim 2, wherein said discrete radial steps are spaced lengthwise at 2 mm increments.

4. The plugger instrument according to claim 2, wherein said discrete radial steps each increase a diameter of said tip by 10%.

5. The plugger instrument according to claim 1, wherein said tip tapers in diameter toward a pointed distal end.

6. The plugger instrument according to claim 1, wherein said tip tapers in diameter toward a flat distal end.

7. The plugger instrument according to claim 1, wherein said discrete radial steps begin at 0.25 mm and taper at 0.02 mm per mm.

8. The plugger instrument according to claim 1, wherein said radial tip comprises a single material of construction, said material chosen to define an appropriate degree of flexibility.

9. The plugger instrument according to claim 8, wherein said single material of construction is selected from the group consisting of chrome plated steel, stainless steel, and nickel titanium.

10. The plugger instrument according to claim 1, wherein said radial tip comprises a central core and an outer layer.

11. The plugger instrument according to claim 10, wherein said central core comprises a first material of construction, said first material defining an appropriate first degree of flexibility.

12. The plugger instrument according to claim 11, wherein said outer layer comprises a second material of construction, said second material defining an appropriate second degree of flexibility greater than said first degree of flexibility.

13. The plugger instrument according to claim 1, wherein said radial tip further comprises a series of color coded markings for depth control during insertion.

14. The plugger instrument according to claim 1, wherein said radial tip further comprises a series of permanently imprinted markings for depth control during insertion.

15. The plugger instrument according to claim 14, wherein said permanently imprinted markings are created by stenciling.

16. The plugger instrument according to claim 14, wherein said permanently imprinted markings are created by laser imprinting.

17. A dental instrument for use in compacting flowable materials into small oral cavities, comprising a cylindrical tip that tapers in diameter toward a distal end by a series of discrete radial steps spaced lengthwise along said tip, said tip further comprising one or more materials of construction to provide an appropriate degree of flexibility and a series of permanent markings to control depth of insertion during said compacting process.

18. The dental instrument according to claim 17, wherein said cylindrical tip tapers in diameter toward a pointed distal end.

19. The dental instrument according to claim 17, wherein said cylindrical tip tapers in diameter toward a flat distal end.

20. A method of obturating root canals comprising the step of exerting vertical, lateral, and angular compaction forces simultaneously on a mass of gutta percha through utilization of a plugger instrument comprising a cylindrical tip that tapers in diameter toward a distal end by a series of discrete radial steps spaced lengthwise along said tip.
